(19) United States
(12) Patent Application Publication
(10) Pub. No.: US 2012/0031830 A1
(43) Pub. Date: Feb. 9, 2012

(54) Transporting and Treating Water

(75) Inventors: David A. Edwards, Boston, MA (US); Joseph Shivers, Salem, OH (US); Kevin Burrows, Solvang, CA (US); Steve Teng, Rego Park, NY (US); Michael Silvestri, Natick, MA (US); Werner Hugo van Vuuren, Cambridge, MA (US); Mathieu Lehanneur, Paris (FR); Jose Sanchez, Paris (FR)

(73) Assignees: Le Labogroup S.A.S., Paris (FR); President and Fellows of Harvard College, Cambridge, MA (US)

(21) Appl. No.: 13/127,921

(22) PCT Filed: Nov. 9, 2009
(86) PCT No.: PCT/US2009/063709

§ 371 Date: Oct. 19, 2011

Related U.S. Application Data
(60) Provisional application No. 61/112,690, filed on Nov. 7, 2008.
(60) Provisional application No. 61/219,139, filed on Jun. 22, 2009.

(51) Int. Cl. B01D 35/00; B65D 33/02; B01D 29/00

(52) U.S. Cl. 210/244; 210/455; 428/12; 220/9.2

(57) ABSTRACT

Water can be transported and/or treated using a system or container in which a collapsible framework is attached to a membrane. A collapsible water container defining a volume for receiving, transporting, and delivering water can include: a membrane of material substantially impermeable to water, the membrane having a substantially cylindrical expanded configuration with a central axis and substantially contracted configuration; wherein the membrane configured to rotatably expand about the axis when water is placed within the volume defined by the collapsible water container and rotatably contract about the axis when water is removed from the volume defined by the collapsible water container.

### TECHNICAL FIELD

This invention relates to transporting and treating water.

### BACKGROUND

Drums such as drums made from low-density polyethylene can be used to transport water in rural areas of undeveloped countries. Such drums can be carried or rolled and can include handles to aid in moving the drums.

Tensegrity is the name associated with structures that retain their form by tension as opposed to pressure. Tensegrity is a portmanteau of “tensional integrity”—it refers to structures that derive their stability from being pulled outward (like a geodesic dome) rather than by being pushed down (like a skyscraper). Standard home building uses pressure to hold joints together—a balloon, or a cell, holds structure together by a state of tension. This is the notion of tensegrity

The classic example of a tensegrity structure consists of rigid elements that are connected to each other by stretchable elements, so that as the rigid elements are pulled away from each other by gravity, they tighten the bands and give the structure stability. “The term refers to a system that stabilizes itself mechanically because of the way in which tensional and compressive forces are distributed and balanced within the structure.”—Don Ingber, leader of the Wyss Institute for Biologically Inspired Engineering.

### SUMMARY

We hope to create a new way to transport, store, and purify water in the developing world in order to improve the lives of the 1.1 billion people who lack ready access to clean water.

Manual water transport relies on containers made of walls with volumes ranging from several ounces to several gallons. These containers generally associate form and function through a few standard variables, namely volume, shape, and material properties of the container walls. Choosing the proper container form variables influences whether the containers will function best for children or adults, men or women, in urban conditions or the countryside, in the developed or the developing world.

The novel water transport vessels described in this application can mimic basic form and function relationships of the biological cell to transport and filter water for developed and developing world applications. These vessels can have the following properties:

1) Like a biological cell, volume expansion of the vessels can correspond to water uptake or filling, and volume contraction to water extraction or draining;

2) Like a biological cell, water can exit the vessels and be filtered in the process;

3) Like a biological cell, the vessels can be transported easily in multiple ways exploiting natural transport pathways;

4) Like a biological cell, the vessels can be assembled and disassembled to improve its natural function.

In one approach, a collapsible water container includes ribs attached to a cylindrical axis member; and a membrane of material impermeable to water, the membrane covering the ribs, and possibly completely integrating the ribs into its material, to achieve the functionality of a ribbed covering design even while the membrane may retain its form and function without the addition of a second structure or identifiable ribs.

In one aspect, a collapsible water container defining a volume for receiving, transporting, and delivering water, includes: a membrane of material substantially impermeable to water, the membrane having a substantially cylindrical expanded configuration with a central axis and substantially contracted configuration; wherein the membrane configured to rotatably expand about the axis when water is placed within the volume defined by the collapsible water container and rotatably contract about the axis when water is removed from the volume defined by the collapsible water container.

Embodiments can include one or more of the following features.

In some embodiments, at least one end of the cylindrical axis member has a hole for entry of water, possibly a funnel configuration. The other end of the cylindrical axis member may allow water to exit the container, possibly to be filtered in the process. The water container can also include a strap extending one end of the cylindrical axis and opposite end of the cylindrical axis and/or a filter inserted into the cylindrical axis.

In some embodiments, the water containers also include a cylindrical axis member; wherein the membrane is attached to the cylindrical axis member. In some cases, the water containers also include support members attached to the cylindrical axis member. The membrane can cover the support members or the support members can be integrated within the membrane.

In some cases, at least one end of the cylindrical axis member has a funnel configuration.

In some cases, the water containers also include a strap extending between one end of the cylindrical axis member and an opposite end of the cylindrical axis member.

In some cases, the water containers also include a filter disposed such that water being placed with the volume defined by the membrane passes through the filter. The filter can be inserted into the cylindrical axis member.

Depending on its volume, the water container can be carried on the head, on the back, on a shoulder, in a bag or pocket, and rolled on the ground. The water container can be made of multiple materials (e.g. cloth and ribs) or a single material, such as a polymeric material with internally fabricated ribs (e.g. the polymer can be created with pre-conditioned folds that permit the folding of the material) so as to expand and contract on water filling and dispensing. The water container can possess a strap that permits its various transport options and at least one face of the water container can detach to permit cleaning of the water container interior. Finally the water container can permit the insertion of a cylindrical filter such as the LifeStraw such that on exit from the water container water can be naturally filtered.

In another approach, a collapsible water container applies tensegrity principles in a design modeled on a biological cell—a functional design and an appropriate metaphor for its lifegiving function. The novel water container represents an elegant way to apply Buckminster Fuller's ideas to fulfill one of humanity's most fundamental needs.

In one embodiment, the cell's interior is a collapsible tensegrity structure, made of eight or more lightweight plastic struts strung together by taut rubber band or cord. Its exterior is a flexible, puncture-proof membrane that has a single, cinch-top opening. The cell can be submerged so that water flows into the membrane's one opening, and this opening can then be cinched tight and sealed with a simple plastic stopper. If the cell is only partially full, it can be collapsed from a sphere into a thick disc. Lightweight clips, for example metal clips, hold this disc compact, so that it can be more easily moved. This transportation method means that the cell can be made narrow in order to move along narrow paths, and that it will retain its structural strength despite its flexibility.

The maneuverability of the full container of either of these approaches provides advantages over existing water transport technologies that rely on carrying or rolling a hard plastic barrel. When empty, the water container can be folded flat for efficient transport by individuals or trucks. When partially full, the water container can have different carrying modalities, and even different functionalities, since it assumes different shapes and sizes. Because the external membrane can be removed, partially or completely, from the inner core, it is easy to wash and dry. Many different membranes, with varying permeability and insulation, could be placed around the frame.

The water container can be rearranged, in size and shape, for improved functionality or, in some cases, the membrane replaced in case of damage. One of the remarkable things about the design is the extent to which it can be customized and re-imagined by its users—an aspect that may appeal to customers in more affluent parts of the world as well. These interactive aspects let the cell illustrate architectural principles, as well as to inspire creativity.

The filter sterilization systems applied to these water containers are requisite in today's laboratories, making their design feasible and affordable on a communitywide scale. Like a living cell, replication of the novel water container incites novel adaptations, and rigorous experimentation will only maximize its effectiveness across different cultures and landscapes. Made from recycled plastics and tire rubber, the water containers can be ecologically and environmentally friendly, and the very tensile forces that cooperate to shape it illustrate the powerful impact that small unified efforts can have on preventing and solving global health crises.

The novel water container designs provide a comprehensive solution to the many problems that prevent developing world communities from accessing clean water, from the energetic and temporal costs of traversing treacherous topography to the hazardous contamination of water sources and containers. Simple yet versatile, the novel water container anticipates and invites alternative uses—from seed storage to recreation to education.

The details of one or more embodiments of the invention are set forth in the accompanying drawings and the description below. Other features, objects, and advantages of the invention will be apparent from the description and drawings, and from the claims.

### DESCRIPTION OF DRAWINGS

FIGS. 1A-1F show a small scale model of a tensegrity sphere.

FIG. 2 illustrates a collapsible sphere.

FIG. 3 illustrates potential uses of the sphere of FIG. 2.

FIGS. 4-18 illustrate an embodiments of collapsible water containers in various configurations.

Like reference symbols in the various drawings indicate like elements.

### DETAILED DESCRIPTION

### Tensegrity Water Container

One design can be a large tensegrity sphere 100 covered by a polymeric membrane 108. The tensegrity sphere 100 consists of rigid members 110 (e.g., plastic rods) connected by flexible cords 112, and the asymmetrical design causes it to compress predictably when stress is applied. The sphere can flatten out completely and be locked in place by a clamping mechanism 114, though it can quickly spring back into its original spherical shape when these clamps 114 are removed. The polymorphic membrane(s) 108 covering the structure are flexible, easy to remove and wash, and interchangeable with other membranes 108 that lend specialized functionalities like insulation and filtration. The full cells 100 can be moved by simple pushing, pulling with a rope, sliding with a ball-bearing inspired collar, or other transport methods. Although the cell is intended primarily to transport and filter water, its versatile design means it could also be used for grain storage, architectural education, or art installation.

We propose to create a two-part structure, with an inner tensegrity core made of hard plastic rods 110 and an outer flexible membrane 108 that can be pulled taut over the core and sealed. When thus assembled, the novel water container can be rolled or (if it is empty) carried without exposing the tensegrity core to the outside world. A disadvantage of this is that the membrane 108 must bear the stress of being rolled around the ground, so it would need to be tough stuff.

For some applications, it might be feasible to use the membrane 108 alone.

For some applications, a single, hard, spherical shell can be used to cover the entire structure. However, this could add expense and detract from some of the novel water containers most appealing elements—including its easy compressibility and slightly-spring-powered feel.

In some embodiments, the membrane 108 is placed on the inside of a tensegrity exoskeleton. However, this could introduce the need to constantly change contact points with the ground. This change of contact points would likely strain the ends of the tensegrity rods 110.

In some embodiments, the structure could be cylindrical rather than spherical, so that it collapsed from a cylinder to a shorter cylinder rather than from a sphere to a disc.

The tensegrity core can include a series of identical, lightweight, hard plastic rods 110 connected by flexible rubbber bands/parachute cords 112. The more we can make from indigenous materials, the better. The rods 110 have apertures or eyelets at their ends, so the bands can pass through.

In some embodiments, the core is configured such that it is relatively easy to dismantle, reassemble, and adjust these structures. For example, different-length rods 110 or bands 112 could be inserted in order to create asymmetric structures that collapse predictably in response to tension.

In some embodiments, one single flexible band 112 is used rather than multiple bands 112. In these embodiments, the structure can be configured to collapse at all places if the single band were pulled at one end.

In some embodiments, one point on the sphere would contain a hard cylindrical protrusion or pedestal, on which the cell could be positioned to rest on and thereby not roll away when placed on a flat surface.

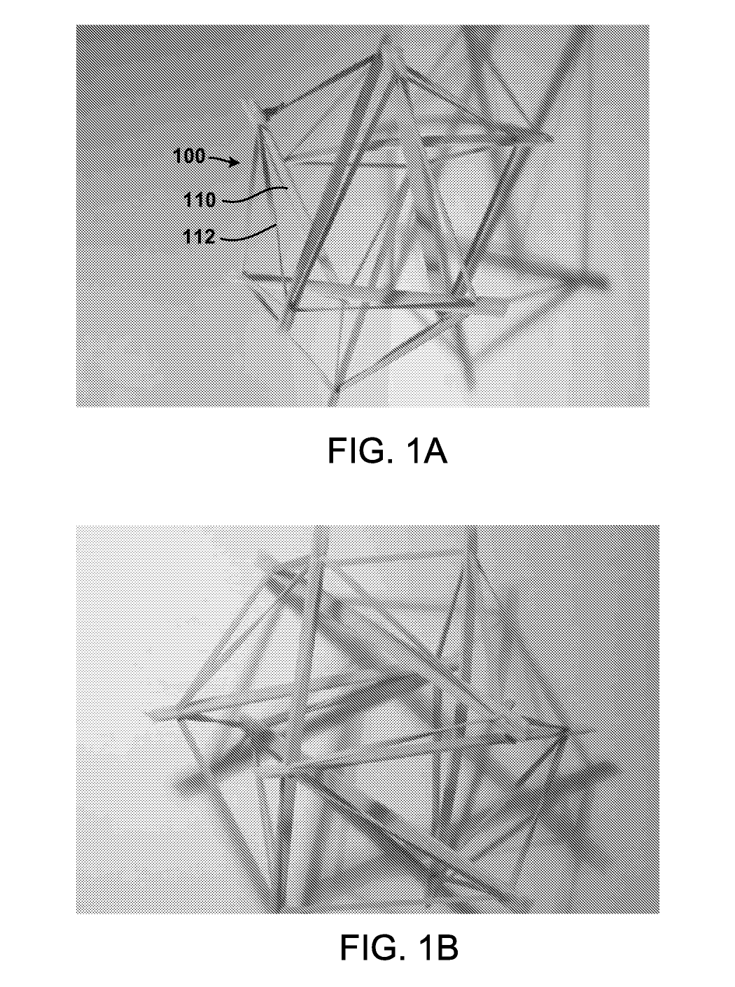

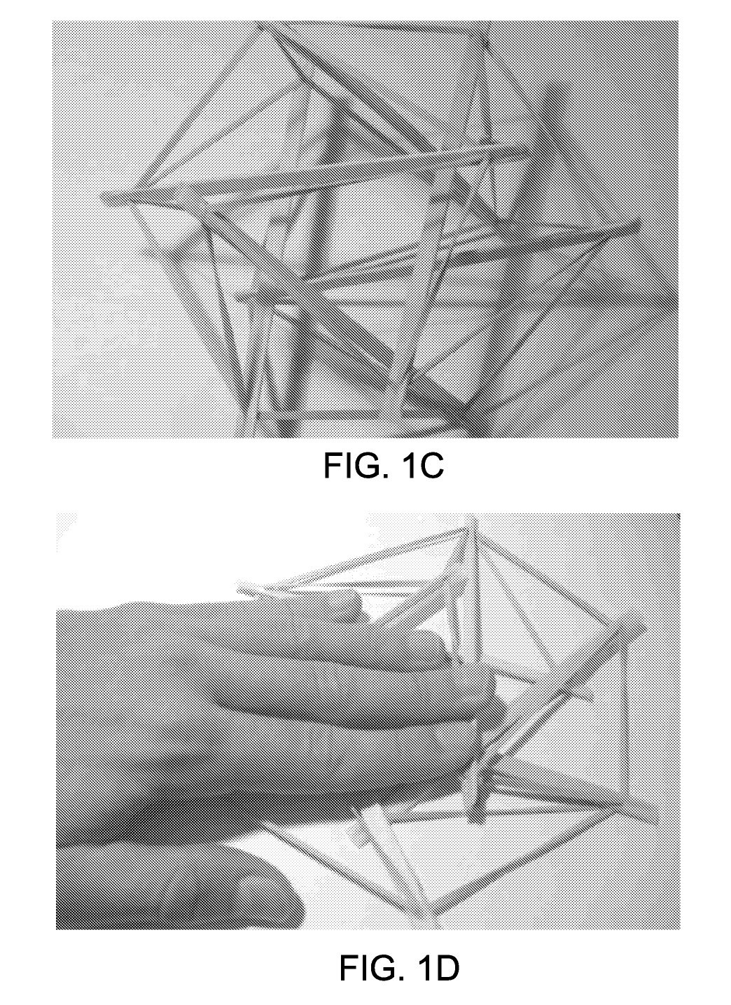

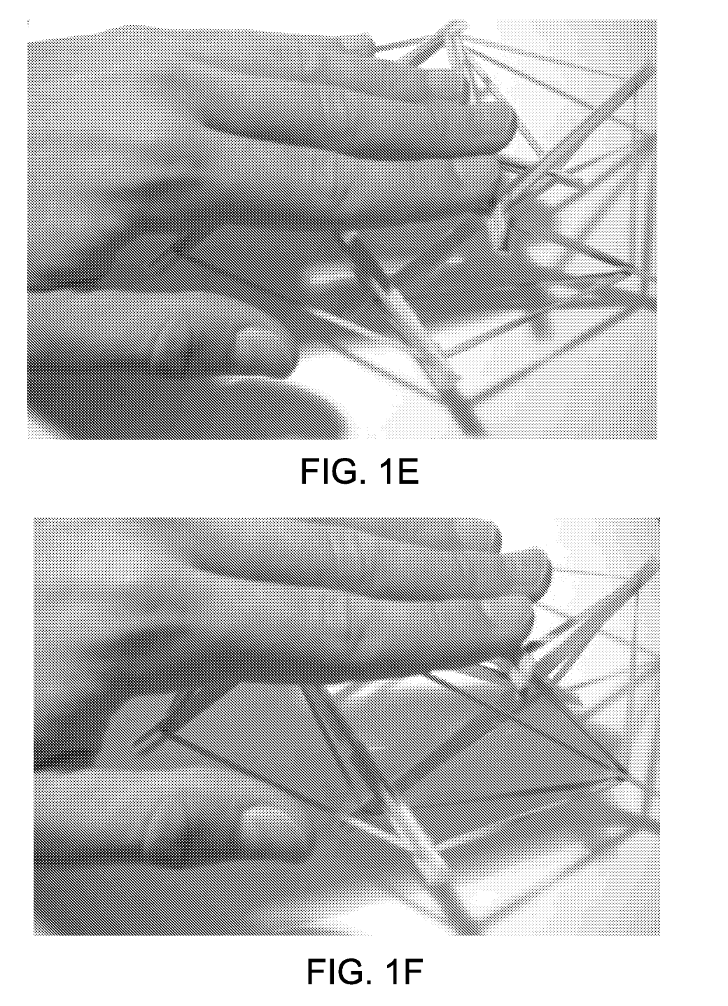

FIGS. 1A-1F show the collapsibility of the structure of a small scale model of a tensegrity sphere. The taut rubber bands pull on it so that it returns to its original shape when the stress leaves. This structure is a simplified version of our tensegrity core, which would contain more rods and thus be more spherical. Also, a membrane could be pulled over the core so that the resulting structure could hold water.

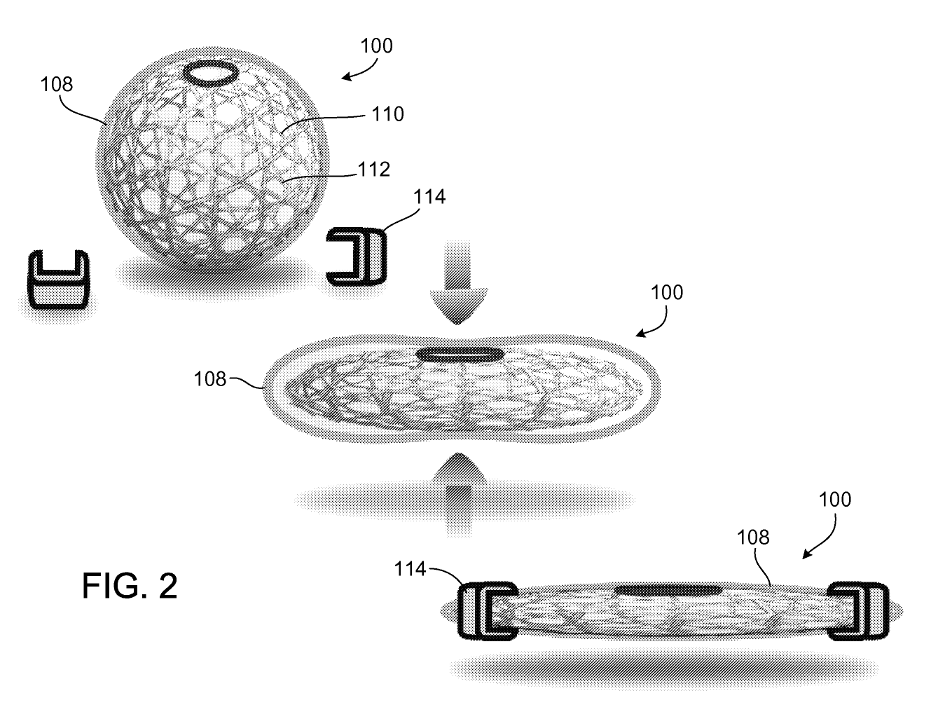

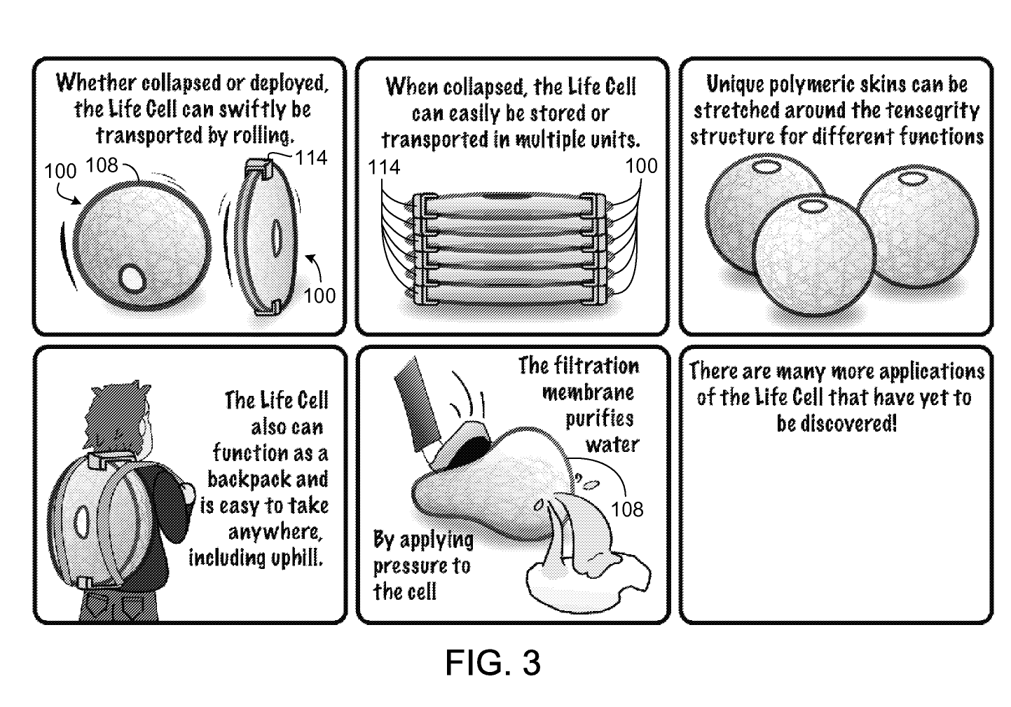

FIGS. 2 and 3 illustrate of the tensegrity sphere water container and a few of its potential uses.

Pumpkin-Shaped Water Container

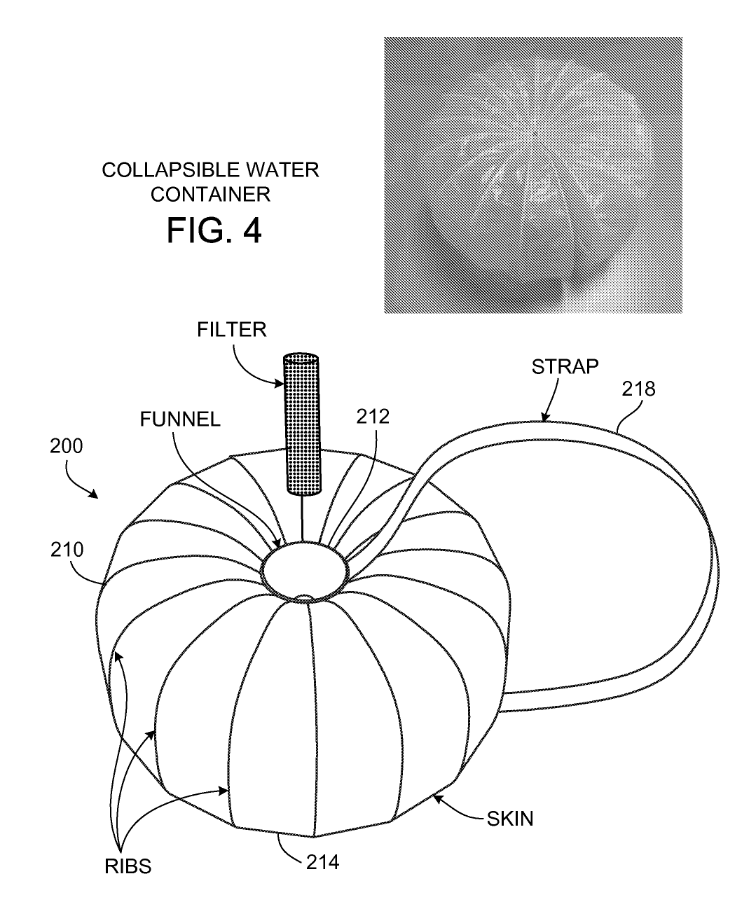

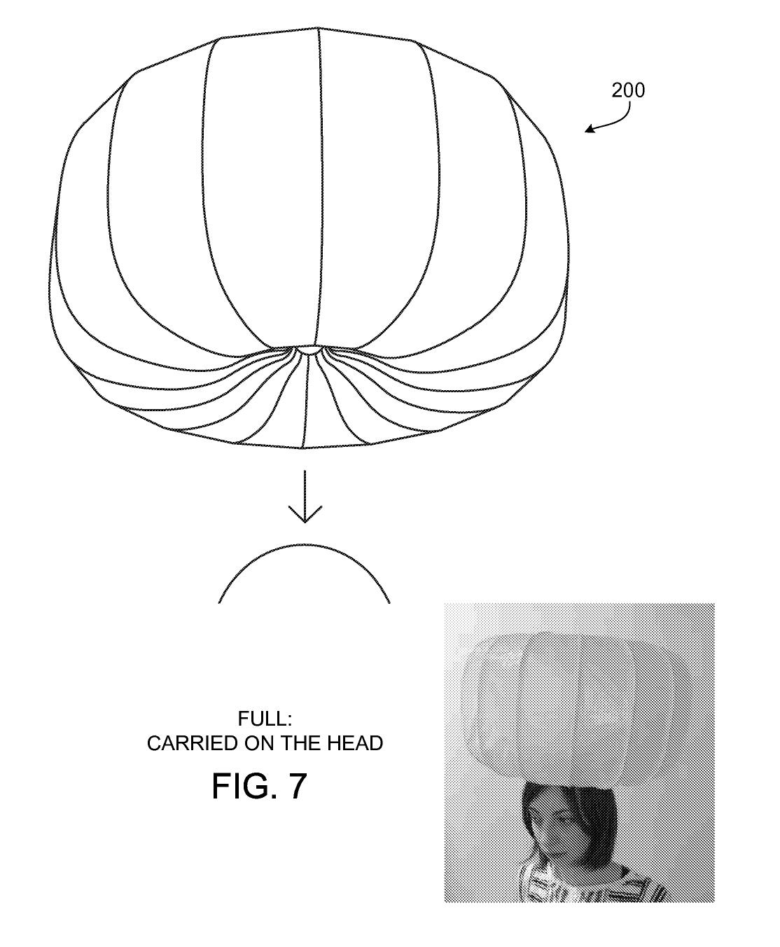

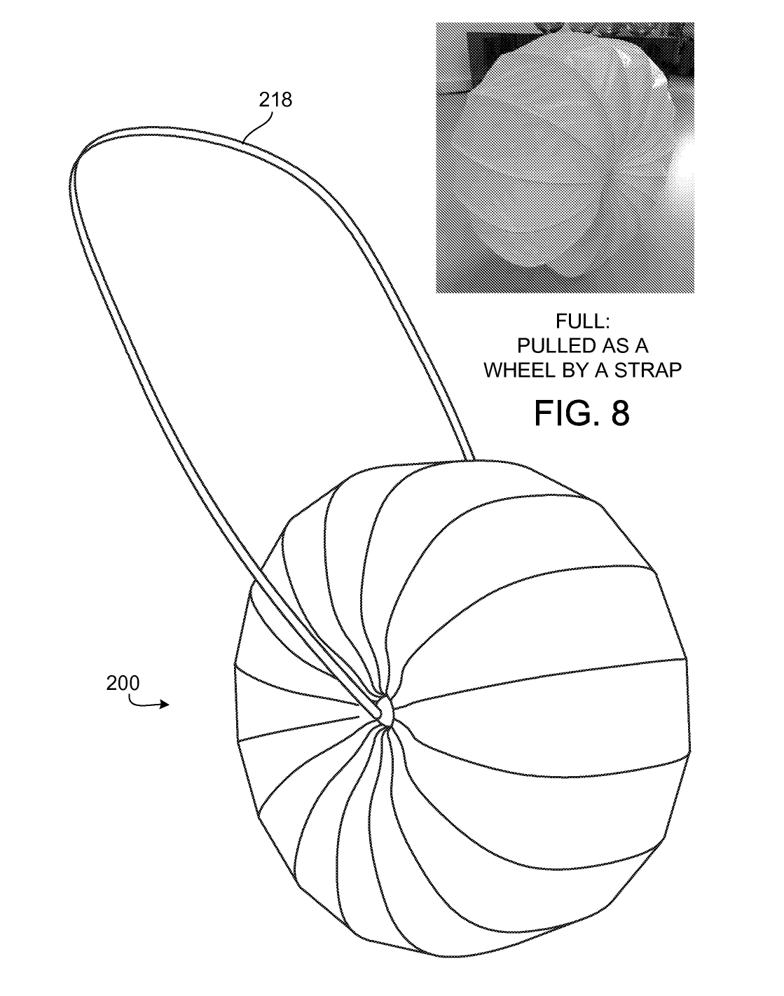

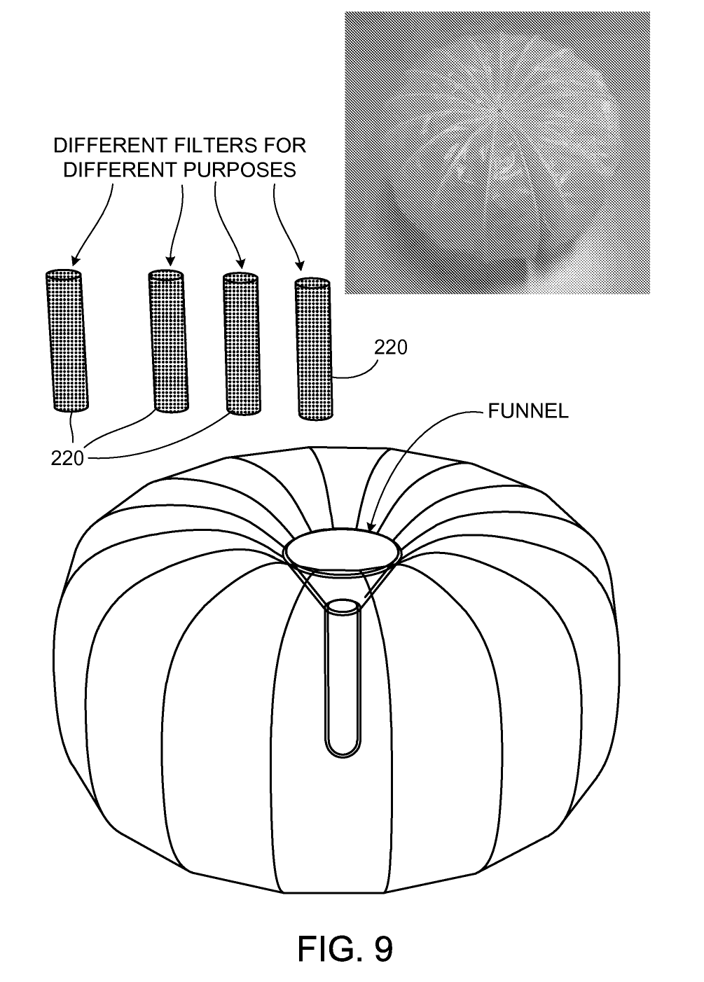

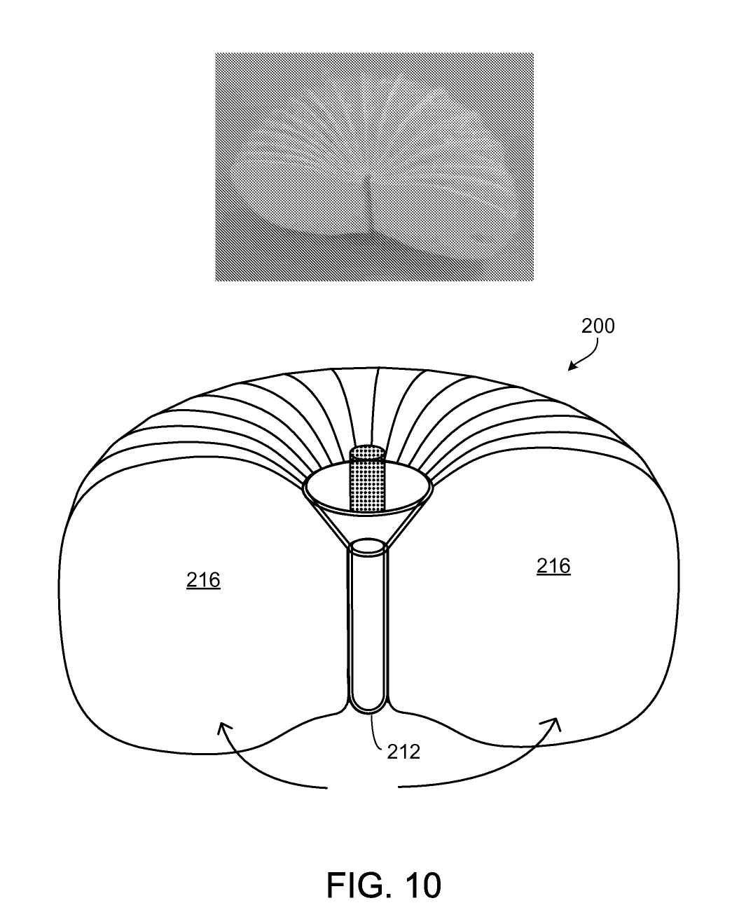

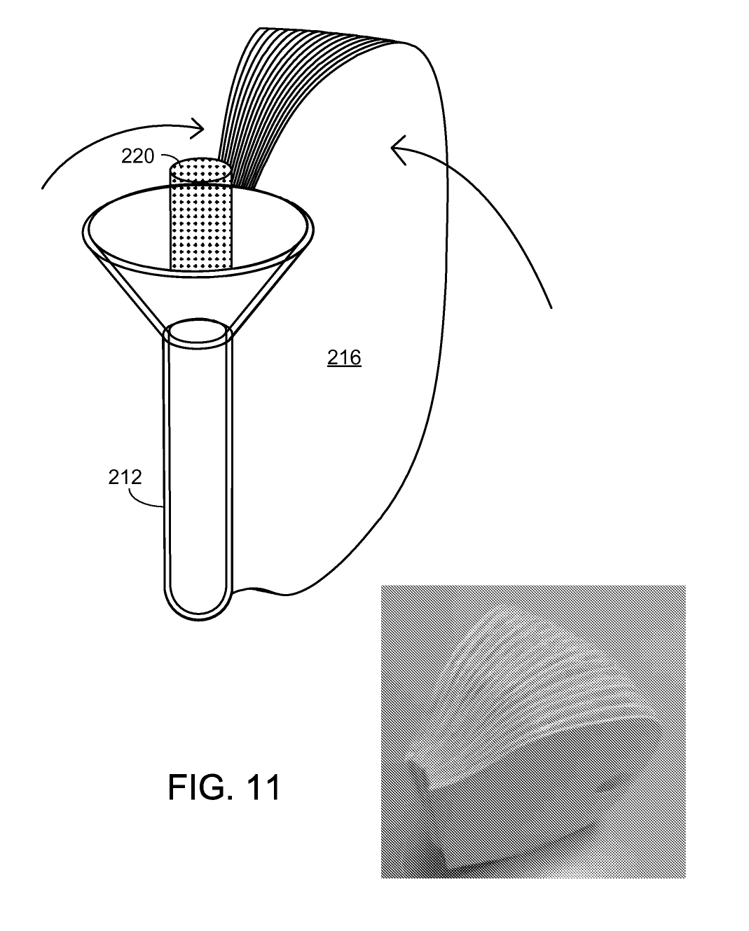

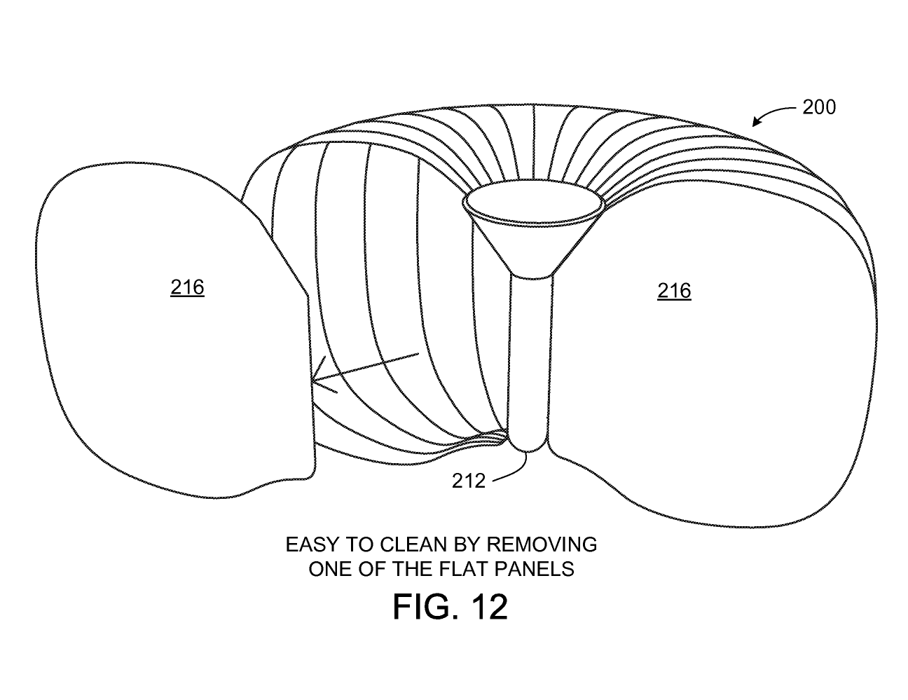

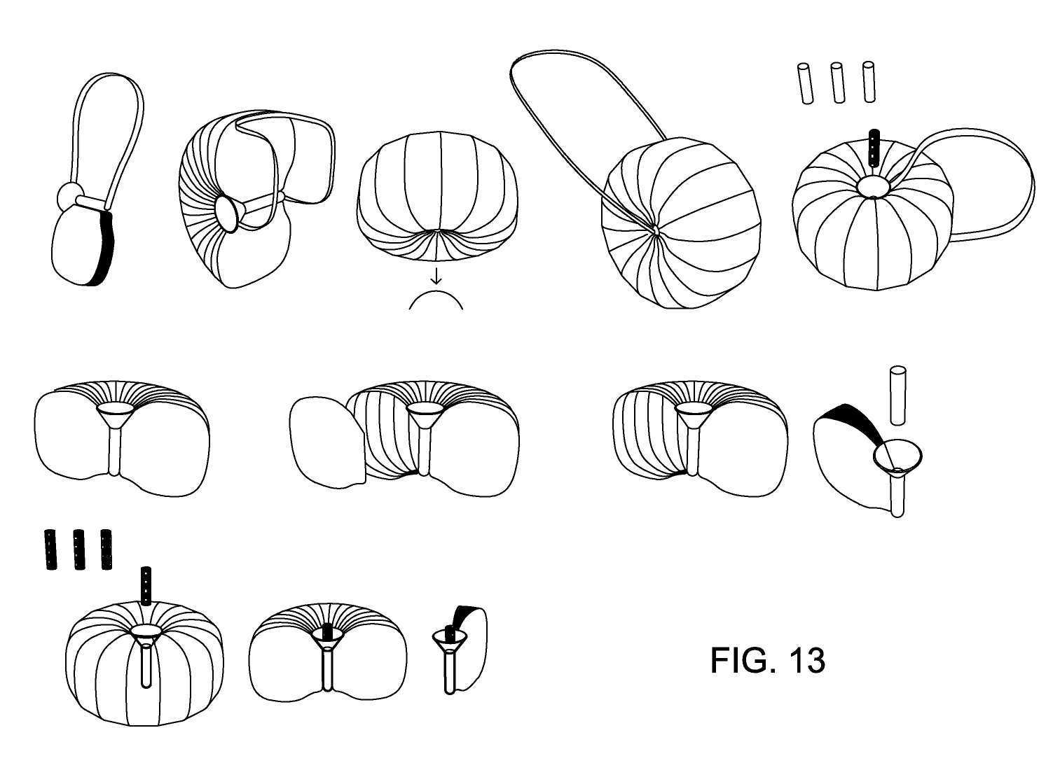

In another embodiment, an easy to make, clean, and use collapsible water container 200 can be formed with ribs 210 attached to a cylindrical axis member 212 (see FIGS. 4-12). A membrane 214 of cloth, plastic, or any material substantially impermeable to water, which provides a kind of skin to the object, covers the ribs 210. The container 200 can be filled with water through one end of the cylindrical axis member 212 and exits either through the same end, by pouring, or through the opposite end upon pressure, applied by collapsing the ribs 210, with pressure applied to the flat panels 216 that provide the backing to the object, in order to form eventually a half-moon object covered by the flat panels 216. The cylindrical axis member 212 of the container 200 permits insertion of a cylindrical filter 220 such as the commercial LifeStraw to permit filtration of water from the container 200. The container 200 can be carried on the head conveniently, when full, or pulled as a wheel by a strap 218, or carried over the shoulder with the strap 218, when not full, or even carried on the back, when half full. By removing one of the flat panels 216, the water container can be cleaned.

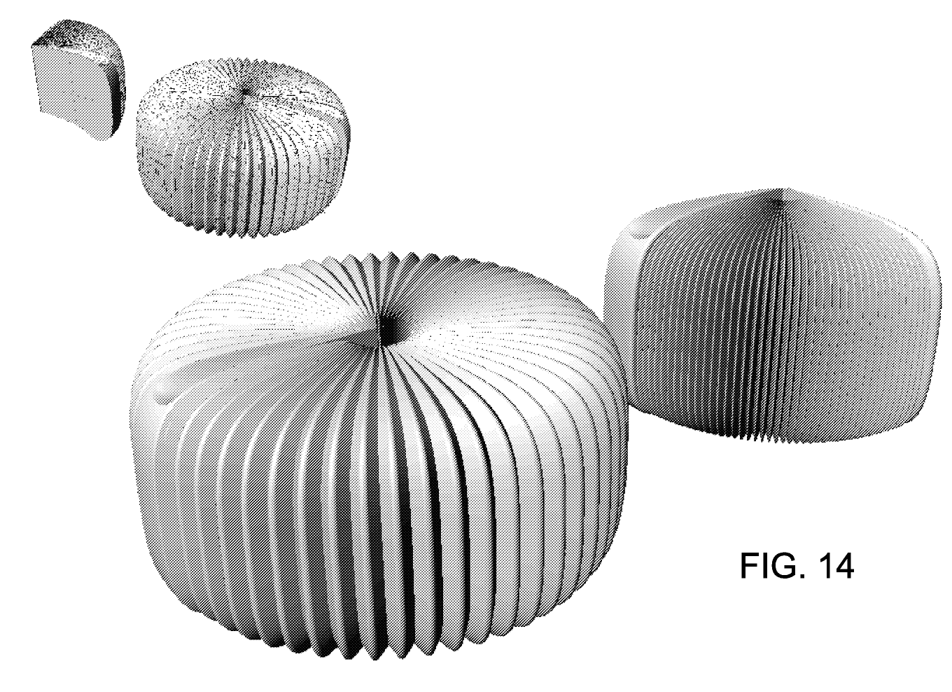

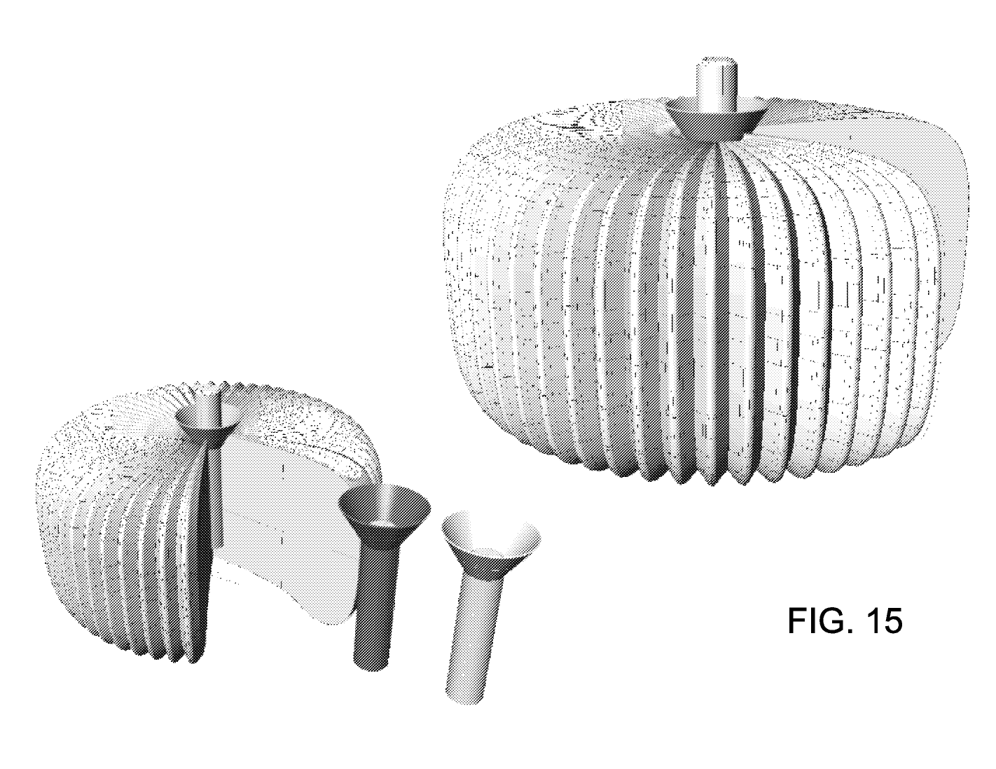

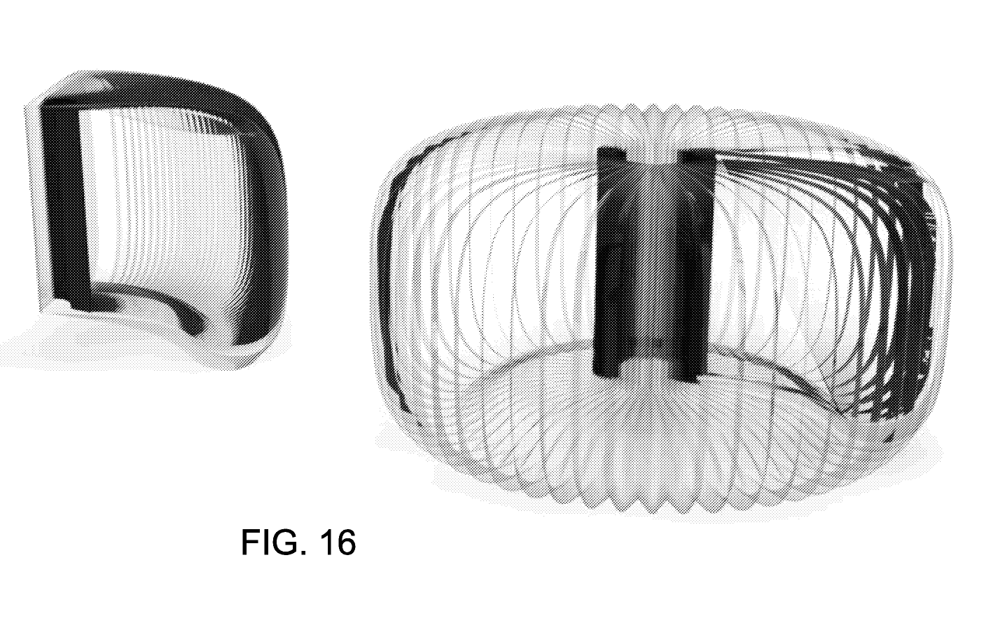

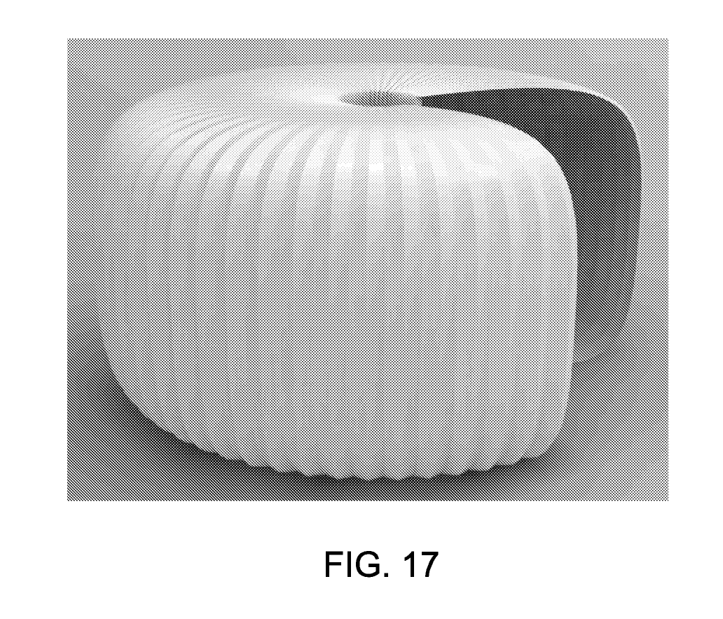

FIGS. 13-18 show embodiments of similar water containers in various configurations. In some embodiments, rather than support members such as the ribs, the membrane 214 is formed with preferential fold lines (see, e.g., FIGS. 16 and 17).

Membrane

In either tensegrity or pumpkin (possibly involving tensegrity elements) embodiments, the membrane 108, 214 of the water containers can be waterproof and puncture-proof, so that it can keep water inside and resist damage despite intense conditions. The membrane 108, 214 can have a single hole, into which water is poured and from which it is extracted. Various ways can be used for sealing this hole in order to transport the full cell. At this point we envision some sort of plastic stopper that can slip in, flush with the rest of the membrane.

In tensegrity embodiments, the opening can be uncinched and the tensegrity core collapsed so far that the core can be pulled out from the inside of the membrane. Similarly, in pumpkin embodiments, at least one of the flat panels can be configured to be removable. These features allow for easy cleaning of the water containers (e.g., such that the covering membrane can be easily washed by hand).

In some embodiments, the hole is sealed by stretching a piece of semipermeable membrane across this opening. These embodiments can be configured so that a user can filter impure water by pressing on the cell until purified water ran out.

In some embodiments, the entire cell is covered in such a semipermeable membrane. These embodiments are not usable for all applications because they can lose a lot of water in transit.

In some embodiments, the membrane is produced from a readily available indigenous material (like rubber from tires).

Transportation

Full

Because water is so dense, transportation is a major challenge. In some embodiments, a full tensegrity sphere or pumpkin water container 100, 200 can be transported by manually rolling the water container along with one's bare hands. In these embodiments, for a full sphere or pumpkin water container 100, 200 to be high enough that it could be comfortably reached, it would have to have such a large volume (and therefore mass) that pushing it would require the application of substantial force. Some embodiments include a sort of handle, ala the Hippo Roller (a sort of barrel-on-a-handle that is useful for transporting water over flat ground).

In another approach, two separate ropes are tied, for example, to a tensegrity sphere about 180 degrees apart on the sphere, so that two people could pull it together. For example, one person would pull on one string and cause the sphere to build up forward momentum, while the other person waited for her string to gain a position at the top of the sphere. Thus tension is exerted only at (or near) the top of the circle, giving more leverage than at the center of rotation.

Similarly, a full pumpkin water container 200 can be pulled as a wheel by a strap 218. Such straps 218 can also be used to carry a pumpkin water container over a user's shoulder when not full, or in a backpack configuration when the pumpkin water container is half full.

Some embodiments of tensegrity sphere-based water containers include a kind of loose collar for the life cell, so that like a ball-bearing, the ball would roll along if the collar were pushed. Friction between the sphere and the collar would be a concern.

Some embodiments of the pumpkin water container can be carried on the head when full.

In some applications, users could pitch stakes in hillsides, and use rough pulley systems to help lift the life cell up steep mountainsides if necessary.

In some applications, the life cell is only partially compressed. This can create a thick disk that could be rolled along its circumference like a wheel or placed on a wheeled platform like a pizza on a skateboard.

Empty

Some embodiments include a clamp 114 (or two, or four) to keep the collapsed life cells 100 from springing open. This would allow them to be stored easily in trucks and trains or just on the ground, and would make it easier for individuals to carry or roll the structure as well.

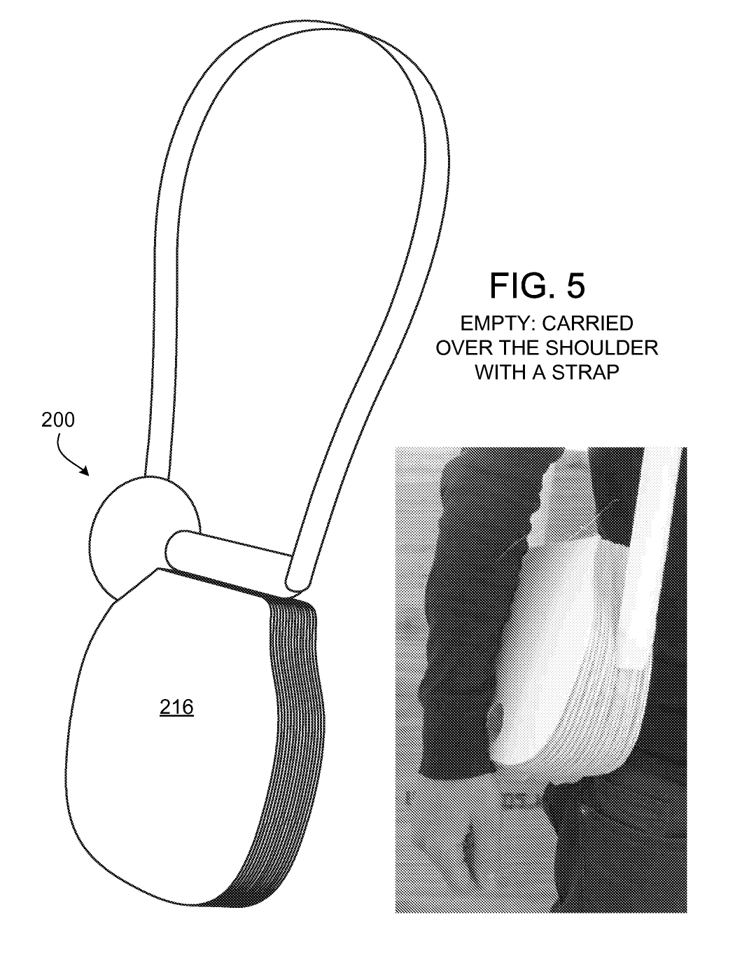

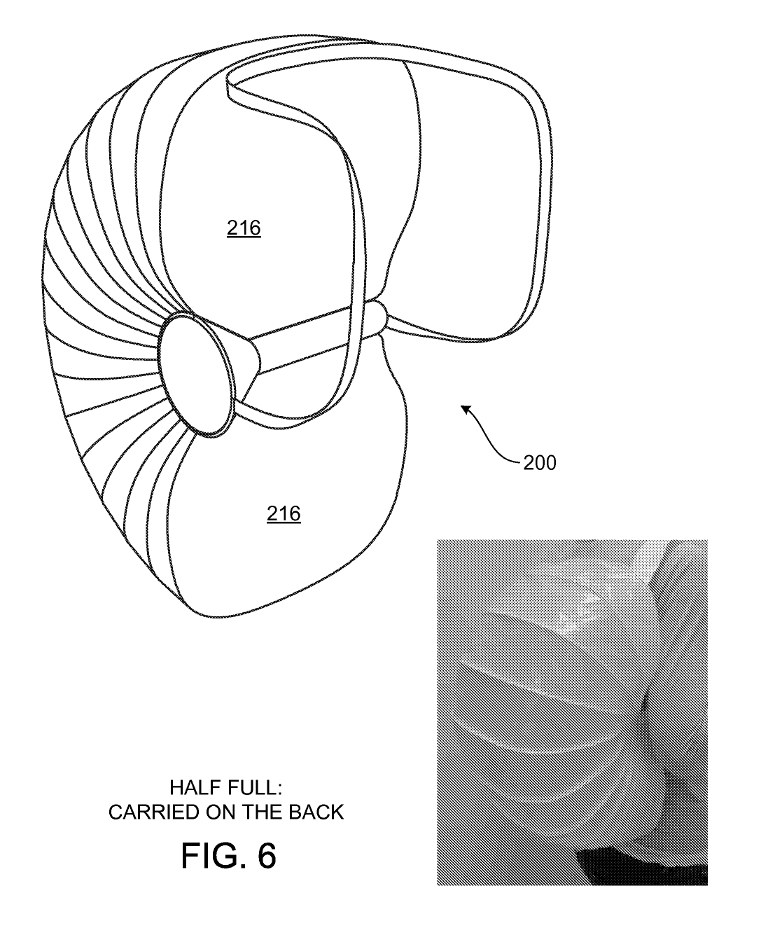

Pumpkin water containers 200 can include such clamps but are not inherently biased towards an open configuration. When empty, the pumpkin water containers 200 can be folded up and carried over a user's shoulder like a purse (see, e.g., FIG. 5).

### Alternate Embodiments

A number of embodiments of the invention have been described. Nevertheless, it will be understood that various modifications may be made without departing from the spirit and scope of the invention.

What is claimed is:

1. A system comprising:
a collapsible framework of rods; and
an outer flexible membrane disposed around the rods, the membrane sealable to enclose a volume.

2. The system of claim 1, wherein the framework includes flexible connectors biasing the framework towards a spherical configuration.

3. The system of claim 2, wherein the framework is collapsible to a substantially disc shaped configuration by force applied to opposite sides of the framework.

4. The system of claim 3, further comprising clamps operable to hold the framework in the substantially disc shaped configuration.

5. The system of claim 1, further comprising at least one strap attached to the flexible membrane.

6. The system of claim 1, further comprising a filter insertable in an opening in the applicable membrane.

7. The system of claim 1, wherein the flexible membrane is a filtration membrane.

8. A collapsible water container comprising:
ribs attached to a cylindrical axis member; and
a membrane of material substantially impermeable to water, the membrane covering, or integrating within the membrane, the ribs.

9. The water container of claim 8, wherein at least one end of the cylindrical axis member has a funnel configuration.

10. The water container of claim 8, further comprising a strap extending between one end of the cylindrical axis member and an opposite end of the cylindrical axis member.

11. The water container of claim 8, further comprising a filter inserted into the cylindrical axis member.

12. A collapsible water container defining a volume for receiving, transporting, and delivering water, the collapsible water container comprising:
a membrane of material substantially impermeable to water, the membrane having a substantially cylindrical expanded configuration with a central axis and substantially contracted configuration;
wherein the membrane configured to rotatably expand about the axis when water is placed within the volume defined by the collapsible water container and rotatably contract about the axis when water is removed from the volume defined by the collapsible water container.

13. The water container of claim 12, further comprising a cylindrical axis member;
wherein the membrane is attached to the cylindrical axis member.

14. The water container of claim 13, comprising support members attached to the cylindrical axis member.

15. The water container of claim 14, wherein the membrane covers the support members.

16. The water container of claim 14, wherein the support members are integrated within the membrane.

17. The water container of claim 13, wherein at least one end of the cylindrical axis member has a funnel configuration.

18. The water container of claim 13, further comprising a strap extending between one end of the cylindrical axis member and an opposite end of the cylindrical axis.

19. The water container of claim 13, further comprising a filter disposed such that water being placed with the volume defined by the membrane passes through the filter.

20. The water container of claim 19, wherein the filter is inserted into the cylindrical axis member.
